(19) United States
(12) Patent Application Publication
(10) Pub. No.: US 2011/0200802 A1
(43) Pub. Date: Aug. 18, 2011

(54) Laser Welding of Polymeric Materials

(76) Inventors: Shenping Li, Painted Post, NY (US); Ellen Marie Kosik Williams, Painted Post, NY (US)

(21) Appl. No.: 13/020,196

(22) Filed: Feb. 3, 2011

Related U.S. Application Data
(60) Provisional application No. 61/305,013, filed on Feb. 16, 2010.

(51) Int. Cl. B32B 7/04; B29C 65/16; B32B 27/00

(52) U.S. Cl. 428/198; 156/272.8

(57) ABSTRACT

Disclosed herein are methods for laser welding together layers of transparent polymeric materials by first making high-contrast marks in transparent polymeric materials using femtosecond, picosecond or nanosecond pulsed fiber lasers and then creating localized welds at the areas of the high-contrast marks. Such welds can be formed in multiple layers of transparent polymeric materials. Systems for making welds and parts welded together according to the methods also disclosed.

### CROSS-REFERENCE TO RELATED APPLICATIONS

This application claims the benefit of priority under 35 U.S.C. §119(e) of U.S. Provisional Application Ser. No. 61/305,013 filed on Feb. 16, 2010.

### FIELD

The present invention relates generally to systems and methods for welding together polymeric material by making a surface or sub-surface mark in the polymeric material using pulsed laser energy, and, in one step or in two steps, creating a weld at the location of the mark. More specifically, the present invention relates to systems and methods for providing laser welds in transparent polymeric materials. Welded materials made by the methods are also provided.

### BACKGROUND

A wide range of methods are used for plastic and polymeric welding. Processes include friction welding (vibration and rotation welding), ultrasonic welding, microwave welding, high frequency welding, hot plate welding and laser welding. The methods best suited for a particular application strongly depends on the properties of the plastics used as well as the application and its associated requirements.

Laser welding of plastics and polymers has been used in various industrial areas including electronics, automotive and life sciences applications. Transmission laser welding is a popular laser welding technique for plastic welding. However, this technique is limited to welding two parts which have different transmission properties. For example, one of the components may be transparent to the wavelength of the laser beam, whereas the other component absorbs the energy of the laser beam. The laser beam passes through an upper (transparent) component and when it hits the surface of the second (absorbent) component the light is absorbed and converted into heat. This heat is passed into the transparent component by thermal conduction, causing the material of both components to melt, and weld together. If both parts have the same transmission properties, in order to adopt this technique, absorption additives need to be inserted between the two components. The absorption additives generally have high absorption at the emission wavelengths of the laser beam used in each case. When the laser beam hits these additives, the additive is heated and plastifies the material by thermal conduction to produce a reliably welded joint. The use of additives not only increases the welding cost and the system complexity, it also creates the potential for contamination which is not acceptable for many applications. For example, plastics used in the life sciences must be free of potentially detrimental contaminants. Additionally, existing laser welding techniques are not able to weld multiple layers of plastics since the necessary absorbing layer prevents the laser beam from reaching past the first welding interface. The development of laser welding methods which enable the welding of multiple layers of material, and the welding of two (or more) parts with the same transmission properties is desirable.

### SUMMARY

In embodiments, the present invention provides systems and methods to weld together two (or more) layers of transparent polymer material. In embodiments, a method for making welds between transparent polymeric materials is provided, comprising providing least two transparent polymeric materials to be welded together, each having a top surface and a bottom surface, wherein the top surface of one polymeric material is adjacent to the bottom surface of another polymeric material and wherein the transparent polymeric materials have transparency windows; providing an optical system structured and arranged to focus a laser beam at a weld spot on the top surface of one polymeric material or the bottom surface of another polymeric material where the transparent materials are adjacent to each other; providing at least one pulsed laser which produces a pulsed laser beam at a wavelength within the transparency windows of the at least two polymeric materials; focusing a pulsed laser beam on the weld spot; wherein the weld spot turns dark in response to the laser beam focused on the weld spot by the pulsed laser; focusing a laser beam at or near the dark weld spot; and, forming a weld zone between the at least two transparent polymeric materials.

In embodiments, the method includes providing additional weld spots between the at least two transparent polymeric materials by re-focusing the pulsed laser beam to additional weld spots. In embodiments, the method includes providing at least three transparent polymeric materials. In embodiments, the method includes providing at least three transparent polymeric materials to be welded together. In additional embodiments, the method includes providing additional weld spots between the at least two transparent polymeric materials by re-focusing the pulsed laser beam to additional weld spots at the interfaces provided by at least three layers of transparent polymeric materials.

In embodiments, the transparent polymeric materials comprise the same transparent polymeric material, or different polymeric materials, having the same or overlapping transparent windows. In embodiments, the transparent polymeric materials may be different, and may be polystyrene, polycarbonate, polyethylene terephthalic ester, poly(phenylene oxide), or blends of any two or more of these polymers. In embodiments, the transparent polymeric materials may be the same and may be polystyrene, polycarbonate, polyethylene terephthalic ester, poly(phenylene oxide) or a blend of any two or more of these polymers.

In further embodiments, the step of focusing a pulsed laser beam on the weld spot is provided by the same pulsed laser as the step of focusing a laser beam at or near the dark weld spot to form a weld zone. Or, in embodiments, the step of focusing a pulsed laser beam on the weld spot is provided by a different laser than the step of focusing a laser beam at or near the dark weld spot to form a weld zone. In embodiments, the laser used to focus a laser beam at or near the dark weld spot to form a weld zone is a continuous wave laser.

In embodiments, the pulsed laser is a fiber laser. In embodiments, the at least one pulsed laser comprises an Yb-doped pulse fiber laser. In embodiments, the at least one pulsed laser provides laser energy at a pulsewidth of less than 1 ns.

In embodiments, the method comprises moving the laser beam in relation to the at least two transparent polymeric materials to be welded together to form a weld zone. Or, in embodiments, the method comprises moving the at least two transparent polymeric materials to be welded together in relation to the laser beam to form a weld zone.

In embodiments, the pulsed laser provides a laser pulse repetition rate is between 50 kHz and 100 MHz, a laser pulsewidth that is less than 1 ns, or less than 500 ps, or between 0.1 ps and 500 ps. In embodiments, the transparent polymeric materials do not contain additives such as pigments, colorants, dyes, foaming agents or blowing agents, to facilitate the formation of a mark or a weld.

### BRIEF DESCRIPTION OF THE DRAWINGS

The invention is best understood from the following detailed description when read with the accompanying figures.

FIG. 1 is a diagram illustrating a pulsed laser beam focused by an optical system on polymeric workpieces to form a weld.

FIG. 2 is an enlarged illustration of the area of FIG. 1 shown by dashed line 1 of FIG. 1.

FIG. 3 illustrates an embodiment of the present invention where a laser beam creating a weld may pass through multiple layers of transparent polymer material to form a weld.

FIG. 4 illustrates that a second weld may be made at a second weld spot between additional layers of transparent polymer materials by re-focusing the laser at a second spot.

FIG. 5 illustrates embodiments of the present invention wherein two lasers may be used to provide a weld between transparent polymeric materials in a one-step process.

FIG. 6 illustrates an additional embodiment of the present invention wherein two lasers may be used to provide a weld in a two-step process and all of the marks may be illuminated by the welding beam simultaneously, in groups, or one at a time.

FIGS. 7A and B illustrates embodiments of the present invention wherein two lasers may be used to provide a weld in a two-step process.

FIG. 8 illustrates embodiments of the present invention where two lasers may be employed to create welds in layers of a multi-layer part.

FIG. 9 is a graph showing a transmission spectrum, including some transparency windows, for polystyrene, measured from a 1 mm thick piece of polystyrene (Dow 685D).

FIG. 10 is a photograph of a polystyrene disc welded to a polystyrene plate according to embodiments of the present invention.

FIGS. 11A and B are photographs of parts (welded together using an embodiment of the two-steps method described in FIGS. 5-8.

### DETAILED DESCRIPTION

Embodiments of the present invention relate generally to a system for welding together two (or more) transparent polymeric parts. For example, embodiments of the invention provide methods for welding together two (or more) plastic or polymer parts having the same transmission properties. These two or more plastic or polymer parts may be transparent to the wavelength of the laser. The two or more plastic or polymer parts may be like material. That is, the two or more parts may be made from the same polymeric material. More specifically, embodiments of the present invention relate to systems for making high-contrast markings in transparent polymeric material (transparent to the wavelength of the laser beam(s)) at or near the interface between two polymeric parts (at a weld spot), using a pulsed femtosecond, picosecond or nanosecond laser and an optical system to provide the laser energy to the weld spot in the polymeric material. Once a mark, or carbonization, is made in the material, this mark acts as a linear absorber for continued or subsequent laser irradiation. Continued or subsequent laser irradiation focused at the high contrast mark, or area of carbonization, creates heat at the location of the high contrast mark. This heat passes through the interface between plastic pieces by thermal conduction to produce a joint or weld between the two parts.

In embodiments, the pulsed laser beam may be re-applied or continued to be applied to the marked area, which is now absorbent to the wavelength of the pulsed laser beam because it has been marked, creating localized heat, which results in a localized melting of the polymeric material, forming a weld. In additional embodiments, a second laser may be used to apply a laser beam to a marked region, creating localized heat at the marked region, forming a seam or joint or weld.

In this detailed description, for purposes of explanation and not limitation, exemplary embodiments disclosing specific details are set forth in order to provide a thorough understanding of the present invention. However, it will be apparent to one having ordinary skill in the art that the present invention may be practiced in other embodiments that depart from the specific details disclosed herein. In other instances, detailed descriptions of well-known devices and methods may be omitted so as not to obscure the description of the present invention.

In embodiments, the first carbonization step and the second heating step are provided by the same femtosecond, picosecond or nanosecond laser. In embodiments, the first marking step and the second heating step may be done by the same laser by applying laser energy, first to form a mark, and then to heat the marked or carbonized area to form a weld, in rapid succession.

In additional embodiments, the second heating step is provided by a second laser. The second laser may be a continuous wave laser or a pulsed laser. The second laser provides a laser beam directed at the area of carbonization, resulting in localized heating due to linear absorption. In embodiments, the marking step and the heating step may occur in separate manufacturing steps which do not occur in rapid succession. That is, a first manufacturing step may include providing a dark mark to a region of a polymeric material where a weld is desired. These parts may then proceed immediately to a welding step, or there may be a time delay between the marking step and the welding step. For example, in embodiments, the marked parts may be stored for later welding. A subsequent manufacturing step may use a second laser to provide laser energy to the marked area where a weld is desired. In embodiments, a weld is created when a first femtosecond, picosecond or nanosecond laser is focused at the site of the desired weld, creating a localized area of carbonization, which absorbs laser energy resulting in heating the material at the localized area sufficiently to form a weld. In additional embodiments a weld is created when a second laser, which may be, for example a continuous wave (CW) laser, is focused at an area that has been marked using the first pulsed femtosecond, picosecond or nanosecond laser, causing that marked area to heat, thereby creating a weld. The wavelengths of the two beams can be either the same or different, but are in transparent window(s) of the two parts to be welded. First, the focus place is locally carbonized by using the pulsed laser beam through the nonlinear absorption. The focus place is close to the joint place of the two parts to be welded. Then, the carbonized material acts as an absorber for the continuous wave (CW) laser beam resulting in local heating through linear absorption. This heat is then passed into the joint place by thermal conduction to produce a reliable joint between the two parts. Both above methods are suitable for welding two or more layers.

Further, in embodiments, marking and welding methods of the present invention provide that the polymeric material does not contain layers of contrasting material, layers of colorable material, contrasting layers, pigments, foaming agents, metallic, reflective, or other laser energy absorbing materials or additives which are linear absorbers within the transparency window of the polymeric material. In embodiments, the polymeric materials that are marked according to embodiments of the methods of the present invention do not have additives which absorb the applied laser energy to form a dark mark. Rather, a dark mark is made by the application of pulsed laser energy, without the aid of laser energy absorbing additives in the polymeric material to facilitate the formation of sub surface dark marks in the polymeric material. In further embodiments, articles made by the method are also provided.

In further embodiments, methods for providing welds between multiple layers of transparent polymeric material are provided. For example, because the layers of polymeric material are transparent to the wavelength of light provided by the marking laser, this laser beam passes through transparent layers without affecting the material. When the laser beam or beams are focused at a position within the object to be welded, a mark can be made, followed by a weld. The laser may then be re-focused at a different spot within the object to be welded to form a second mark and a second weld. The laser may be re-focused by an optical system which may include lenses, mirrors, diffractive optics and polarization optics are well known in the laser art.

For example, a layered product may be formed by stacking layers of transparent polymeric material into the desired structure, and creating laser welds according to embodiments of the present invention by focusing the marking laser on a first layer to be welded, then on a second layer to be welded, then on a third layer to be welded, and so on. For example, if a multi-layer assembly is to be laser-welded together, according to embodiments of the present invention, a laser may be focused at the lowest layer to be welded, a mark may be made, and then the marked area may be further exposed to focused laser energy to create localized heat, creating a weld. Then, the laser may be re-focused at the next lowest layer to be welded, a mark may be made, and then the marked area may be further exposed to focused laser energy to create a second area of localized heat, creating a second weld. This may be repeated multiple times. Because the material does not contain pigment, or layers of absorbing material and is transparent to the wavelength of the laser beam until a mark has been made, a laser may be focused down through a multiple layer part without obstruction, and without creating unwanted areas of heat, marks or welds. In other words, the laser beam can travel through layers of transparent polymer material until it is focused at the spot or area to be welded without damaging other areas or creating unwanted marks or welds. In this way, a multi-layer transparent polymeric product can be manufactured by re-focusing a laser or lasers through the product without the use of pigments, colorants, dyes, foaming agents or additives, blowing agents or layers of contrasting material to the polymeric material, or on surfaces of polymeric material.

It is advantageous from a cost and process standpoint, as well as from a safety perspective, to be able to laser-mark and laser-weld transparent polymeric materials without adding laser energy absorbing materials such as pigments, colorants, dyes, foaming agents or additives, blowing agents or layers of contrasting material to the polymeric material, or on surfaces of polymeric material. It is advantageous from a cost, process, and product function standpoint, to be able to laser-mark and laser-weld polymer materials, including transparent polymer materials, without additives and without damaging the surface of the polymer material. In addition, embodiments of the present invention allow for laser welding of multiple layered parts without the requirement of additives, absorption materials or masks. These laser welds create less debris and contamination than other methods known in the art for joining together polymeric parts (for example, sonic welding). In addition, no waste or by-products are produced using embodiments of the present invention. Embodiments of the present invention allow for highly precise and flexible welding and welding design. Embodiments are suitable for use in industrial environments as fiber pulse lasers can be used for high speed welding due to the high repetition rate pulses. Very fine welds may be accomplished, or thicker welds may be accomplished using embodiments of the present invention.

It is useful and desirable to mark and weld together parts that are made of the same material, including transparent materials. It is useful and desirable to mark and weld together transparent polymer material that does not contain pigments or layers of absorbing material. Methods of creating marks in polymeric material have been disclosed in, for example, U.S. patent application Ser. No. 12/510,360 filed on Jul. 28, 2009 entitled Method for Providing Sub-Surface Marks in Polymeric Materials, incorporated herein in its entirety to the extent that the disclosures are not inconsistent.

In embodiments of the present invention, “transparent polymer” or “transparent polymeric material” means a polymer or polymeric material which has sufficient transparency to the laser wavelength and which does not contain laser energy absorbing additives such as dyes, pigments, contrast agents, blowing agents, foaming agents, metallic or reflective materials or layers of materials which contain these additives. In embodiments, the transparent polymer is any polymer or blend of polymers which does not contain laser energy absorbing additives. In additional embodiments, the transparent polymer is, for example, polystyrene, polycarbonate, polyethylene terephthalic ester, poly(phenylene oxide), cyclic olefin copolymer, or copolymers or blends of two or more polymers. In embodiments, the transparent materials are like materials. For example, two layers of the same polymeric materials may be welded together according to embodiments of the present invention. In additional embodiments, the two layers are different materials that have overlapping transparency windows. That is, the two or more materials have at least some region of transparency windows in common. In commonly used laser welding applications, the polymeric materials to be welded together often cannot be like materials, because in order to provide a laser weld between two materials, the two materials usually need to have different transparency windows. If the two materials are not like materials, a laser may provide a laser beam through a top layer of material that is transparent to the laser energy, to reach a second layer of material that is not transparent to the laser energy. When the laser energy contacts the material that absorbs the laser energy, localized heat is generated and welds can be formed. In contrast to these commonly used laser welding techniques, embodiments of the present invention allow for laser welding of like transparency polymeric materials. In embodiments, the transparent polymer that is marked according to methods of the present invention is provided without additives that would affect the transparency of the polymeric material to the wavelength of laser energy being used to mark the transparent polymeric material. In embodiments, the transparent polymeric material is free of laser energy absorbing additives. In additional embodiments, the polymeric materials may be different materials. However, different materials should have overlapping transparency windows to allow the laser to pass through layers of different polymeric material.

In embodiments of the present invention, methods for welding together transparent polymeric material such as polystyrene, polycarbonate, polyethylene terephthalic ester, poly(phenylene oxide), cyclic olefin copolymer, or other polymers, or copolymers or blends of two or more polymers, or like material, without the need for laser energy absorbing additives such as pigments, colorants, dyes, foaming agents or additives, blowing agents or layers of contrasting material are provided by first making a dark mark in or on the transparent polymeric material and then exposing the marked material to a laser beam that creates localized heating and localized welding are provided. The invention takes advantage of short femtosecond, picosecond, or nanosecond duration laser pulses which have high energy densities and interact nonlinearly with the polymeric material creating dark marks or carbonization. By focusing or crossing these short duration laser pulses at a position where a desired weld is to be made, a dark mark may be made. In a subsequent exposure to a laser beam, by the same or a different laser, this dark mark provides contrast which may be used to absorb laser energy, creating localized heat which results in a laser weld at the location of the mark.

High-contrast marks or dark marks, for the purposes of this disclosure, means marks that may be visible to the human eye, and/or machine readable, and are darker than the surrounding material. For example, a high-contrast or dark mark may appear in a transparent polymer material to be a black, brown, purple, blue, green or other high-contrast, dark or colored mark.

Embodiments of the present invention also provide a layered transparent polymeric product having a series of laser welds in stacked layers of materials, formed by focusing a series of short femtosecond, picosecond, or nanosecond duration laser pulses at the layers to be welded together to create dark marks, followed by exposing the marked regions to laser energy which create localized heat at the location of the dark marks and create laser welds.

In embodiments, a single laser source may be used to introduce high-contrast or dark marks into the body of a transparent polymer material. The wavelength of the laser pulses should be within the transparency window of the polymer material. Because the wavelength of the laser pulses are within the transparency window of the polymeric material, individual laser pulses can pass through the polymeric material without affecting the material until the laser energy is focused or crossed with another laser beam to provide sufficient energy to interact nonlinearly with the polymeric material, causing it to carbonize, and leaving a high contrast or dark mark. In additional embodiments, when multiple laser pulses having an appropriate energy are focused at a single spot within the polymeric material, and are timed so that the laser pulses reach the focal spot at the same time, a dark spot may form at the focal spot. Without being limited to a theory, this laser energy, from more than one source, focused at a single spot, may combine to break down the polymeric material. The combination of these laser pulses may create non-linear absorption in the material, causing changes in the polymeric material. The polymeric material may burn or char, also called carbonization. The polymeric material may create soot which is trapped inside the locally heated polymeric material to form dark areas or spots. In embodiments of the present invention, these dark areas or spots are weld spots. When the polymeric material or the laser(s) are moved in relation to each other, larger regions of dark marks and welds may be formed. These are weld areas or weld zones. For example, a joint or seam may be provided by forming dark spots at the focal spot of the system, and them moving the polymeric materials to be welded together in relation to the laser. Additional spots are formed, which may be in the form of lines, areas, or any shape required by the application. These shaped spots form darkened areas which, when exposed to additional laser energy which is absorbed at the location of the darkened areas to cause localized heating, and melting together of the polymeric materials, forms a weld area or weld zone. In embodiments of the present invention, the polymeric material itself is free of pigments. In embodiments, the polymeric material is free of colorants. In embodiments, the polymeric material is free of dyes. In embodiments, the polymeric material is free of foaming agents. In embodiments, the polymeric material is free of blowing agents. In embodiments, the polymeric materials is free of layers of material containing any one or more pigments, colorants, dyes, foaming agents or blowing agents.

In embodiments, combinations of short, highly energetic laser pulses induce a photochemical reaction in the polymer in which the material is locally carbonized, resulting in permanent blackening of the lasered area. The blackened features are on the order of 0.1-100 times the size of the laser focus and this size can be tailored for different applications. By moving the polymeric material or workpiece in relation to the focal point of the laser or lasers, or by moving the focal point of the laser(s) in relation to the workpiece, shapes may be provided in the workpiece including lines, curves, two-dimensional geometrical shapes, three-dimensional geometrical shapes, or any other desired shapes or features.

Laser marking of polymers has been demonstrated using, for example CO₂ and YAG lasers. These lasers are not able to provide femtosecond or picosecond pulsewidths. They may be able to provide nanosecond pulsewidths. These processes generally require additives such as foaming agents (or blowing agents), absorbers, colorants, pigments, dyes or the like to achieve a color change sufficient for providing a useful mark. For example, graphite, carbon black, copper-containing compounds, molybdenum oxide, TiO₂-containing compounds, Prussian Blue, pseudobrookite-coated mica or muscovite may be added to a polymer or plastic bulk batch, or may be incorporated as a single or multiple layer into a larger product. Upon exposure to laser energy, for example laser energy generated by a Nd:YAG laser, but the laser may be any type of laser having a wavelength in the wavelength region of high absorption of the pigment used, the pigment may carbonize, creating a mark. (See U.S. Pat. Nos. 5,928,780, 5,977,514 and US. Published Application 2006/0030631 and Japanese laid-open (Kokai) publication No. H05-337659.)

Femtosecond lasers have been used to ablate polymers without discoloration (P. Moreno et al., Femtosecond laser ablation of carbon reinforced polymers, Applied Surface Science: 252 (2006) 4110-4119) and to create carbon micro-structures from polystyrene (J. Ashcom et al., Femtosecond laser-induced carbonization of polystyrene, Conference on Lasers and Electro-Optics (CLEO): (2001) p. 231). In addition, laser marking devices have been described which introduce marks into polymeric material (US Publication No. 2007/0086822). However, these marks were very light and required a layer of core material or colored material, to increase the visibility of the marks.

In embodiments, the present invention provides methods for using femtosecond, picosecond, or nanosecond laser pulses with high-repetition rates (50 kHz-30 MHz) to make high-contrast (black) sub-surface marks in transparent polymer material, without creating damage to the surface of the material. The polymeric material is transparent to the laser wavelength. In embodiments, these methods do not require colorants. In embodiments, these methods do not require pigments. In embodiments, these methods do not require dyes. In embodiments, these methods do not require foaming agents. In embodiments, these methods do not require blowing agents. In embodiments, these methods do not require layers of contrasting materials or layers of materials containing colorants, dyes, foaming agents or blowing agents.

Fiber pulse lasers are very suitable for generating 50 kHz-30 MHz femtosecond, picosecond and nanosecond pulses. Because of the advantages of fiber lasers: low cost, high stability, high reliability, compact size, and low maintenance, the use of these lasers for embodiments of the present invention are inherently low cost and suitable for use in industrial environments. In addition, since high-repetition-rate pulses are used, these methods can provide high speed marking and welding.

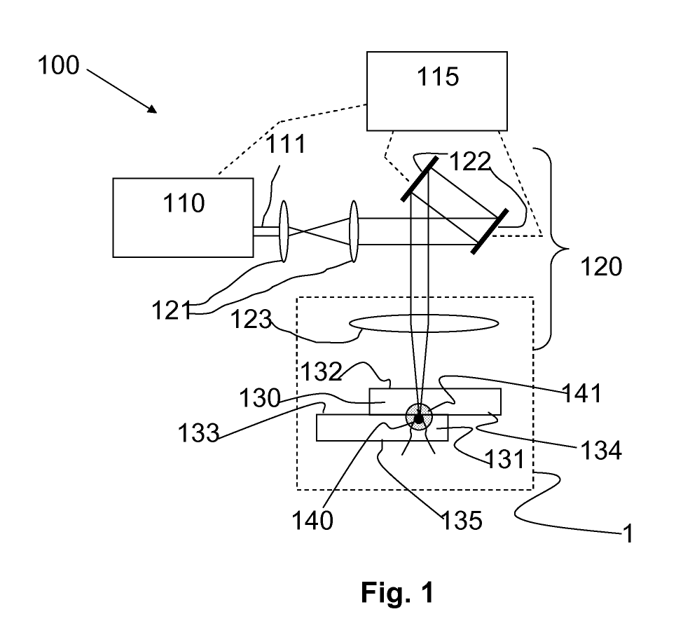

FIG. 1 shows an embodiment of the laser welding system 100 of the present invention using a single pulsed laser beam. The system illustrated in FIG. 1 includes four parts: a pulse laser 110, a controller 115, an optical system 120, which, as illustrated in FIG. 1 including lenses 121, mirrors 122, a third lens 123, and a first workpiece 130 to be welded to a second workpiece 131. The workpieces 130 and 131 are transparent polymeric material. (For the purposes of this disclosure the term “workpiece” is transparent polymeric material and the two terms may be used interchangeably.) Each workpiece has a top surface (132 and 133) and a bottom surface (134 and 135). The laser 110 generates a collimated laser pulse beam 111. The laser pulse beam size is adjusted and focused by an optical control system which may include lenses 121, mirrors 122, and additional lenses 123. As shown in FIG. 1, the laser pulse beam 111 is generated by the laser 110, the laser pulse beam size is adjusted by lenses 121, is and then the direction of the laser beam is controlled by mirrors 122 and focused by another lens 123 to deliver the laser beam to a weld spot 140. The controller 115 may control the laser 110 and the optical system 120 (as indicated by the dashed lines in FIG. 1). This weld spot 140 may also be described as a mark 140. When the collimated laser pulse beam 111 is directed to or focused at or near to the spot 140, a regional heating takes place in a heating zone or a weld zone 141. In this disclosure, the term “at or near” means that while the focal point of a laser is a very precise point, the effect of focused laser energy in a polymeric material may extend beyond the focal point of the laser. In addition, the presence of laser energy focused at a point may cause the point, in a polymeric material, to move and change. That is, when a collimated laser pulse beam is focused at a spot on a top surface of a polymeric material, the polymeric material changes. For example, it may melt, carbonize, and turns dark. The spot which may have been at the surface of the polymeric material may not, after exposure to laser energy, be at the surface of the polymeric material. It may be near the surface of the polymeric material. Similarly, when laser energy is directed to an area that has been marked by exposure to pulsed laser energy, the polymeric material will melt and change. It will form a weld zone. This welded area may not form precisely at the focal point of the laser, or at the precise location of the darkened mark. The weld may form near the focal point of the laser or near the precise location of the darkened mark. Because the polymeric material changes in response to the application of laser energy, the term “at or near” is used in this disclosure to more accurately describe the location of a spot or a weld. In addition, the focal point of the laser beam need only be at or near the surface of a polymeric material in order to effect a laser weld, in embodiments of the present invention. For example, a laser focal point which creates a dark mark below the surface of a polymeric material may function just as effectively to serve as the absorbing point to form a weld as would a focal point at the surface of a polymeric material.

The application of additional laser energy to the darkened region may be applied at or near the darkened region. Because the darkened region or dark spot, or weld spot, absorbs laser energy and creates localized heating, the focus of this heating laser energy, in embodiments, need to be as precisely controlled as is required for the formation of the dark mark. Therefore, the laser energy applied to the polymeric workpieces to create heat at the location of the dark mark or weld spot may be provided “at or near” to the dark mark, which will be understood by those of ordinary skill in the art. The weld spot 140 may be at or near, for example, the top surface of the lower workpiece, or the bottom surface of the top workpiece. In embodiments, the spot is at or near the surfaces to be welded together, so that the heating zone or weld zone 141 occurs at a location where a joint or weld between two workpieces is desired. In additional embodiments, methods for providing welds between separate polymeric parts or layers of polymeric material where dark marks are formed internal to the polymeric material are provided. That is, in embodiments, a dark mark may be formed at a position in a first polymeric part or layer or a second polymeric part or layer which is not adjacent to a neighboring part or layer of polymeric material, but which is close enough to the location of the desired weld that when a regional heating takes place, a weld is formed in the desired location. This may be accomplished by tailoring the beam size and shape at the weld spot such that suitable energy intensity is reached for appropriate localized melting of the polymeric material, and the formation of a weld. In embodiments, laser beam 111 may be multiple laser beams provided by multiple lasers that are focused at spot 140 to create a dark mark 140 at or near the interface of two layers of transparent polymeric material 130 and 131. These multiple beams may be generated by pulsed lasers, and may provide coordinated pulse energy. That is, the pulses of laser energy may be timed so that pulses are delivered to the focal point at the same time. In embodiments, the laser beams can be generated by a single laser or a number of different lasers. The wavelengths of the lasers may or may not be the same. However, the wavelengths of all lasers should be within the transparency window(s) of the material of the workpiece.

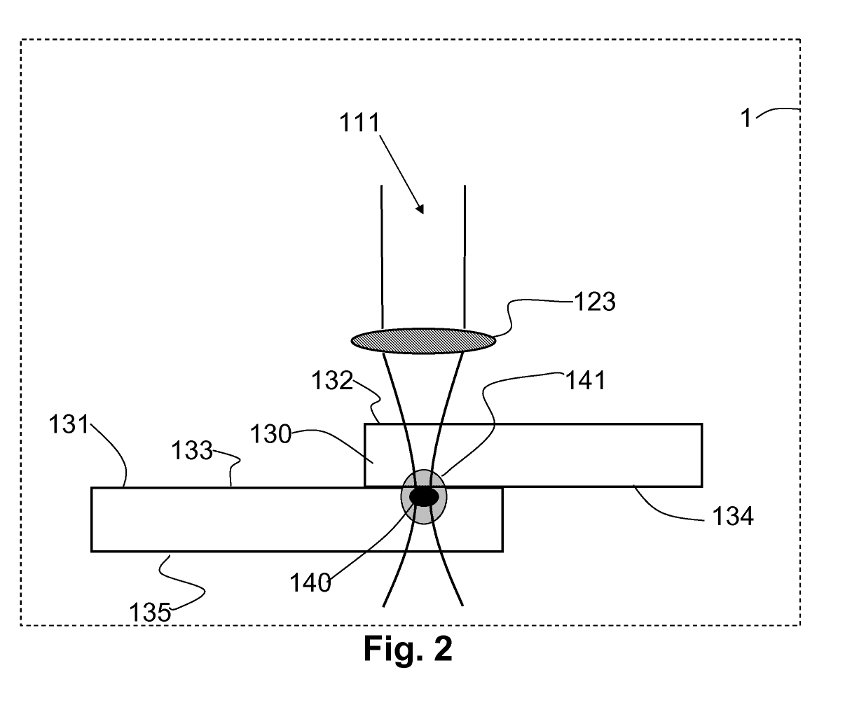

In embodiments, the methods of the present invention include using an optical system 120, to provide pulsed laser energy from a single pulsed laser 110 to a particular spot 140 at or near the surfaces of workpieces to be welded together. These optical systems 120 which may include lenses, mirrors, diffractive optics, polarization optics and controllers are well known in the laser art. The optical system is represented in FIGS. 2-7 by dichroic mirror 125 and lens 123 (where applicable). However, those of ordinary skill in the art will recognize that the optical system 120 may contain additional elements.

In embodiments of the present invention, laser 110 may have the following specifications. The wavelength of the laser pulses should be within the transparency window(s) of the material to be marked. The pulsewidth of the output pulses may be in the femtosecond, picosecond, or nanosecond range. For example, the pulsewidth of the output pulses of the laser is limited only by the physics of the laser and may be between 0.3 ps and 100 ns. Or, the pulsewidth of the output pulses may be less than 1 ns, less than 500 ps, less than 100 ps, less than 50 ps, less than 20 ps, less than 10 ps, less than 5 ps, less than 1 ps or any suitable range.

In embodiments, the pulsed laser will have a repetition rate. The repetition rate is the number of pulses per second. The repetition rate of the output pulses of the laser is any value in the range from, for example, 1 kHz to 100 MHz, 20 kHz to 100 kHz, or from 100 kHz to 10 MHz. In embodiments, the repetition rate of the laser pulses may be any value in the range from 50 kHz to 500 MHz. Fiber pulse lasers are suitable for generating such laser pulses. Higher repetition-rate pulses may allow for more marks per second, which may allow for more welding to be provided between polymeric materials per second. Higher repetition-rate pulses may allow for higher-speed marking and welding. The use of high-repetition-rate pulses may be advantageous as it increases the marking volume (or area) without increasing pulse energy. For example, when the repetition rate of the pulses is high enough, multiple consecutive pulses can interact with the material in the same focal area. Without being limited by theory, it may be that a first pulse produces a permanent structural change or carbonization at the focal point, which results in linear absorption in that spot for the following pulses. This affect may lower the light intensity threshold for the surrounding area, thus larger marking area can be achieved. As long as the repetition rate is below the thermal limit, in the marking step (but not in the welding step), while keeping the pulse energy constant, the higher the repetition rate of the pulses, the higher the marking speed.

In embodiments, depending on the duration of the pulses, the energy of the output pulses of the laser may be selected between, for example, the energy of the output pulses of the laser is selected between 10 nJ to 100 mJ or 10 nJ to 10 mJ, depending on the needs of the system. For example, if the pulse is of shorter duration, the energy required to create a high-contrast mark in the polymeric material may be decreased. If the pulse is of a longer duration, the energy required to create a high-contrast mark in the polymeric material may be increased. All three of the above-described parameters may be altered to create a laser pulse that has an appropriate pulsewidth, combined with an appropriate repetition rate and sufficient energy to create a sub-surface dark mark in a particular transparent polymeric material for a particular beam size or focusing conditions.

The pulse laser can be any kind of laser which meets the above specifications, including gas lasers, solid-state lasers, semiconductor lasers, or others. Pulse fiber lasers are well suited for generating such kinds of pulses. They are low cost, compact in size, high reliability, and maintenance-free. For example, Tl:Sapphire, YAG, Nd-doped glasses, Yb-doped pulse fiber lasers, Er-doped pulse fiber lasers and CO₂ lasers may be used. Fiber pulsed lasers are suitable for generating 50 kHz-50 MHz femtosecond, picosecond and nanosecond pulses. For example, IMRA μJewel (available from IMRA America, Ann Arbor, Mich.) and Corelase® X-lase® fiber lasers (available from Rofin-Sinar, Plymouth, Mich.) may be used. SpectraPhysics Spitfire (available from Newport, Mountain View, Calif.) may be used to generate femtosecond pulses. In an embodiment, the laser may be a high energy, ultrashort pulse fiber laser such as that disclosed in copending US Publication No. 2008/0025348 or a low-repetition rate ring-cavity passively mode-locked fiber laser as described in copending U.S. application Ser. No. 11/823,680 (both incorporated herein by reference). Fiber lasers are generally low cost, high stability, high reliability, have a compact size, and have low maintenance requirements, making these lasers suitable for use in industrial environments.

Turning again to FIG. 1, in embodiments of the invention, an optical system 120, which can include, for example, a single element lens or multiple element lens system 120, may be used to focus a pulsed laser beam 111 at a focal point or spot 140 at or near the surfaces of workpieces, at the interface between the two workpieces, to be joined or welded together. For the purposes of this disclosure, “interface” means a location at or near a surface to be welded to another surface. For example, the interface between workpieces 130 and 131 may be just below the top surface of lower workpiece 131 (as shown in FIG. 1), or just above the bottom surface of upper workpiece 130 (not shown). As long as the laser beam is focused at or near the location of the desired weld, and a dark mark is formed at that location, a weld can be formed at that location, or that interface. The optical system 120 may also tailor the beam size and shape at the focal point 140 such that suitable optical intensity is reached for nonlinear absorption. In addition, a welding seam can be achieved by either moving the laser beam 111 in relation to the workpieces 130 and 131, or moving the workpieces 130 and 131 in relation to the laser beam 111. In addition, to keep close contact at the welding interface, a clamping device may be needed (not shown). The clamping device may be also used to keep both joining parts fixed and to provide a pressure against the thermal expansion within the joining area, which results in an inherent joining pressure for obtaining a material conclusive joint or weld. If the clamping device covers the area to be welded, the clamp should be made of materials transparent to the laser.

The material to be marked 130 may be plastics or polymers which are transparent for the laser light. FIG. 2 is an enlarged illustration of the area of FIG. 1 shown by dashed line 1 of FIG. 1. FIG. 2 illustrates the laser beam 111 focused by the optical imaging system (represented by lens 123), to a spot. In the embodiment shown in FIG. 2, the spot 140 is just under the surface of the second workpiece 131. However, in additional embodiments, the spot may be at or near the bottom surface 134 of the top workpiece 130. That is, the spot may be at the interface between workpieces 130 and 131. Upon the introduction of the focused pulsed laser energy to a spot 140, an area of the transparent polymer material is heated to create a heat zone or weld zone 141. In embodiments, a single pulsed laser is used to create an area of carbonization 140 which also creates a heat zone or weld zone 143. As shown in FIG. 1 and FIG. 2, the heat zone or weld zone 143 occurs in both the upper workpiece 130 and the lower workpiece 131. In embodiments, this single introduction of a heat zone or weld zone 143 may create a weld or joint between the upper 130 and lower 131 workpieces. In this embodiment, the process is a one-step laser welding process.

When the repetition rate of the laser pulses is high enough, multiple pulses can interact with the materials at the same focus volume. The first few pulses produce the permanent structural change or the carbonization at the center of the focus volume, creating a dark mark, which results in the linear absorption in that place for the subsequent pulses. This linear absorption significantly increases the heat efficiency of the laser pulses. Therefore, the welding efficiency can be optimized by properly controlling the repetition rate of the laser pulses.

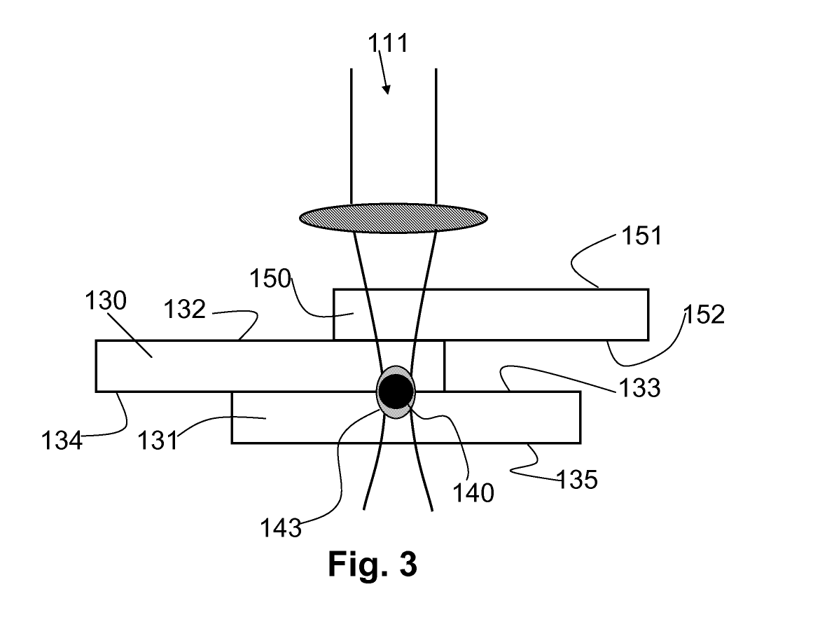

FIG. 3 illustrates an embodiment of the present invention wherein a laser beam creating a weld may pass through multiple layers of transparent polymer material to form a weld. For example, in embodiments, the pulsed laser beam may pass through layers of polymeric material that is transparent to the laser beam before reaching the focus point or spot 140 where a weld is created. FIG. 3 illustrates multiple layers of workpieces, 150, 130 and 132, each having a top surface and a bottom surface (150 and 151, 132 and 134, and 133 and 135 respectively). FIG. 3 illustrates the part after a weld 143 has been created, according to the embodiments shown in FIGS. 1 and 2, between workpiece layers 130 and 131. Because the polymeric material of all of the layers of material are transparent to the wavelength of the pulsed laser beam, no laser-opaque material is required either in the material itself or in the area of the desired welds. Therefore, upon the introduction of laser energy, no welds are created outside the focus area or spot. In this way, layers of material may be welded together by re-focusing the laser to a higher layer, and creating new welds in successive layers of material without the use of laser-opaque materials or layers of laser energy absorbing materials.

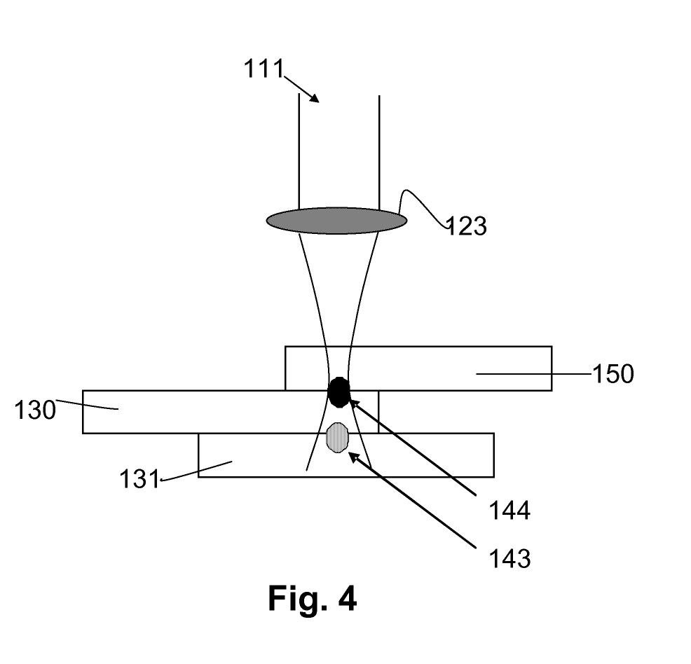

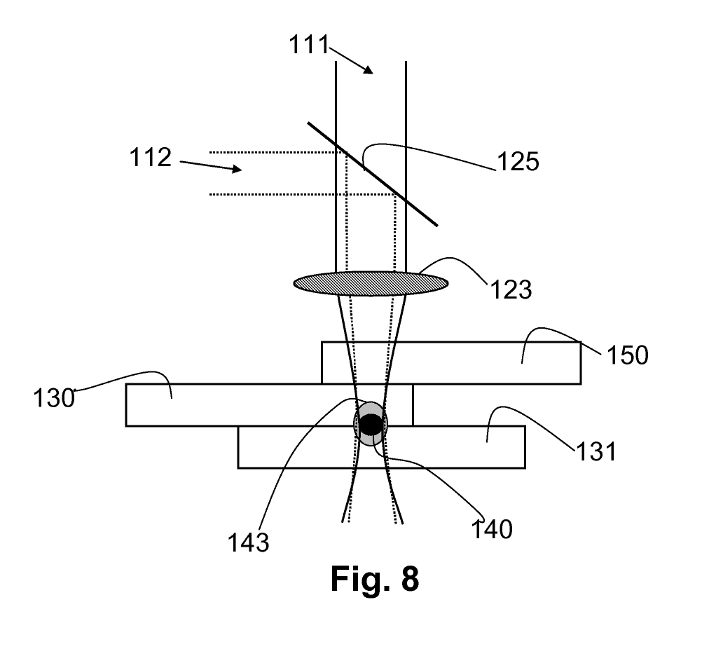

FIG. 4 illustrates that a second weld may be made at a second weld spot between additional layers of transparent polymer materials by re-focusing the laser at a second spot. In embodiments, because the unmarked layers are transparent to the laser beam and allow the laser beam to pass through the material without affecting the material, multiple welds can be made in multi-layered products. As shown in FIG. 4, a weld made at the intersection of layers 130 and 131 at welded spot 143, and a re-focusing of the laser 111 at a second weld spot 144, after the formation of a weld at spot 143. In embodiments, the weld spot may be a weld line, and a weld line or joint may be made by moving the laser in relation to the workpieces or moving the workpieces in relation to the laser beam. Because the laser pulses can be focused at any place inside the bulk material of the parts, this method is suitable for welding multiple layers. When welding multiple layers, the welding order of the layers should start from the bottom (output side of the laser beam) to the top (input side of the laser beam). For example, FIGS. 4 and 8 show the schematics of the welding setup for three layers. In principle, the number of layers to be welded is unlimited. The only requirement is that the materials of all layers, with the possible exception of the bottom layer, are transparent to the laser pulses.

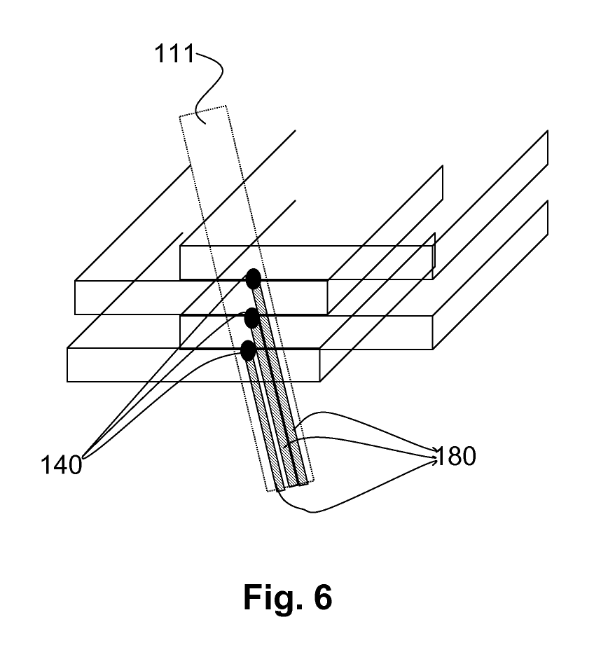

In an additional embodiment, a multilayer assembly may be made by first making dark marks 140 at various depths, as discussed above, and then providing a welding beam 111 to all the marks as shown in, for example, FIG. 6. All of the marks may be illuminated by the welding beam simultaneously (as shown in FIG. 6), in groups, or one at a time. In embodiments, the welding beam may be delivered in such a way or at such an angle that the multiple dark marks do not create shadows that might interfere with welding at the location of additional dark marks. As shown in FIG. 6, the welding beam 111 is provided at an angle so that the shadows 180 created by the welding beam directed against dark marks 140 do not interfere with the delivery of the welding beam to additional dark marks.

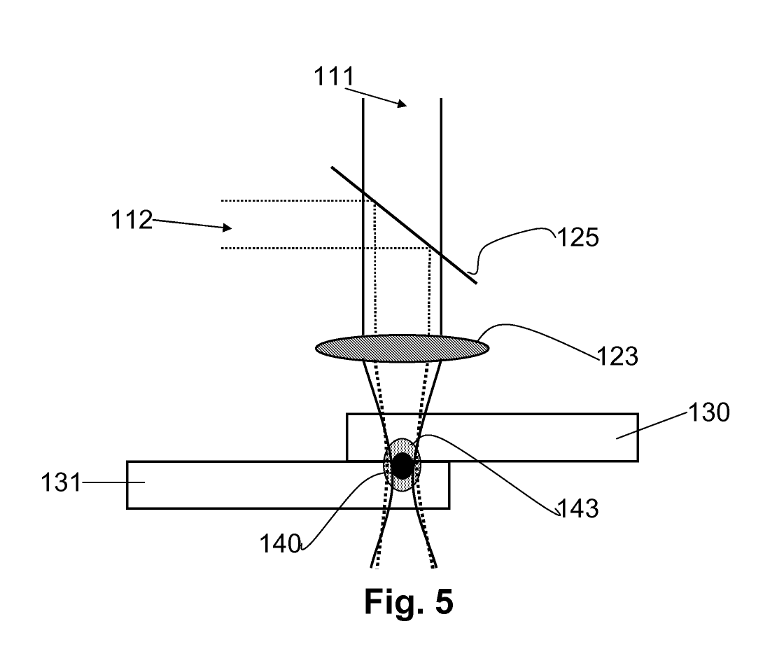

FIG. 5 illustrates an embodiment of the present invention wherein two lasers are used. The first laser beam 111 is generated by any suitable type of laser including gas lasers, solid-state lasers, semiconductor lasers, continuous wave lasers or pulse lasers. In embodiments, the first laser is a pulse laser having a first wavelength (λ₁). The second laser beam 112 may be generated by may be any type of laser. In embodiments, the second laser is a continuous wave or a pulse laser with a wavelength (μ₂) within the transparent window(s) of the materials of plastic/polymeric parts to be welded, but is absorptive to the carbonized or marked polymeric material. The wavelength of the two lasers (μ₁ and λ₂) may be the same or different. If the second laser is a pulse laser, the pulsewidth of the laser pulses may be any value larger than 0.5 ps. In embodiments, the repetition rate of the laser pulses may be any value larger than 1 kHz. In embodiments, the (average) power output of the second laser is larger than 0.1 W. A dichroic mirror 125, which is high transmission at wavelength (μ₁) and high reflection at wavelength (μ₂) can be used to combine the two laser beams. An optical imaging system (represented by lens 123) may be used to focus the two beams at or near the welding place although both beams need not be focused to the same focal volume or same depth in the material.

In the embodiment shown in FIG. 5, a first laser beam 111 is focused at or near to a spot 140 close to the interface of the two workpieces, 130 and 131 to be welded. Because the wavelength (μ₁) of the first laser beam which may be produced by a pulsed laser is within the transparent window(s) of the materials of the two parts, the energy of the laser pulses can be delivered to the focus place inside the bulk material of the two parts. By properly controlling the pulse energy and the pulse duration, the laser intensity only in the focus volume can exceed the threshold of the nonlinear absorption (through nonlinear effects, such as a two- or multi-photon absorption) or the breakdown threshold of the materials. This results in the permanent structural change or carbonization (spot 140) of the material at the focus volume. Then, the carbonized place is illuminated by the beam of the second laser with wavelength (λ₂). Because the wavelength (λ₂) of the laser is transparent to the materials of the two parts and is absorptive to the carbonized material, the absorption occurs only at the place of the carbonized material. Thus, the carbonized place can be locally heated by the beam of the second laser through linear absorption. This heat is then passed into the joint interface by thermal conduction to produce a small plastified volume which results in a reliable joint or weld 143 between the two parts 130 and 131. In embodiments, the two laser beams can be simultaneously delivered to the parts to be joined. As shown in FIG. 5, this method can provide a weld in one-step.

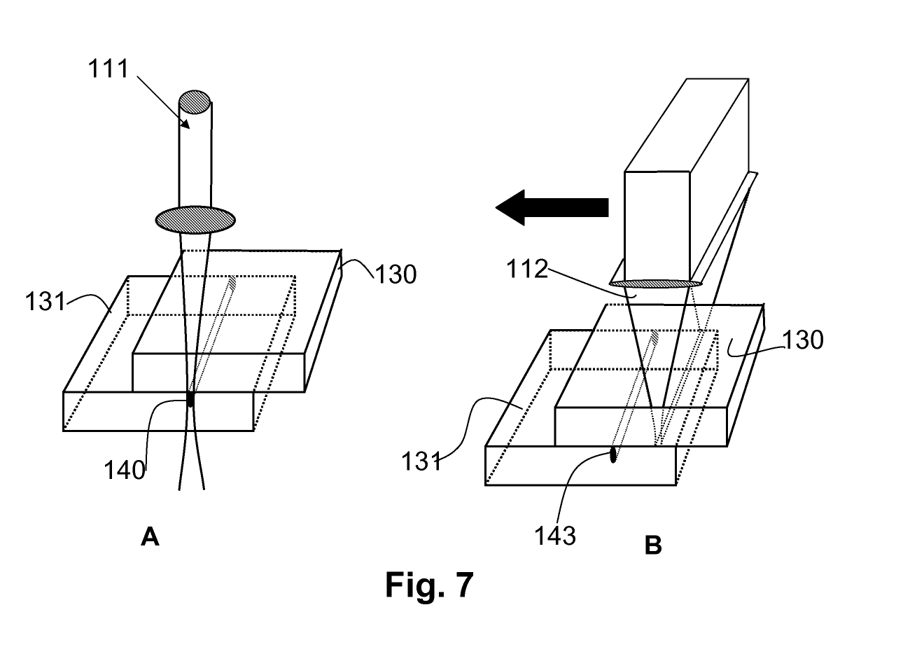

In additional embodiments, as shown in FIGS. 7A and B, the method can provide a weld in a two-step process. In FIG. 7A, A first laser beam, which may be produced by a pulsed laser, having a wavelength (λ₁) is focused at a spot 140 at or near the interface of two transparent polymeric parts 130 and 131, creating a dark mark, or an area of carbonization, as described above in FIGS. 1 and 2. FIG. 7B illustrates that the laser beam 112 may be shaped to sweep across the workpiece or workpieces 130 and 131, to form a weld. For example, in a subsequent step, a second laser 115 (not shown), producing a laser beam 112 having a wavelength (λ₂), may be passed across (as shown by the arrow) the workpiece or workpieces 130 and 131, that have been marked according to FIG. 7A, to form a weld or joint 143. By properly shaping the laser beam, the entire weld seam can be irradiated as a whole. This is a two-step method.

FIG. 8 illustrates embodiments of the present invention wherein two lasers may be employed to create welds in layers of a multi-layer part. As shown in FIG. 8, a first laser 111, which may be a pulsed beam laser having a wavelength (λ₁) and a second laser 112 which may be a continuous wave laser having a wavelength (λ₂) may be focused first at the interface between lower layers of a multi-layer polymeric product. For example, as shown in FIG. 8, the two-laser assembly may be focused at the interface between two lower layers of transparent polymeric material, 130 and 131 to create a dark mark and a weld between those two layers of material. Then, the optical system (represented by dichroic mirror 125 and lens 123) may refocus the two laser beams at a higher location, for example at or near the interface between layer 130 and layer 150 of the multi-layer assembly. As the lasers are refocused, a new dark mark and weld may be made at the higher location within the multi-layer assembly. In this manner, multiple welds may be provided in a multi-layer assembly of transparent polymeric material.

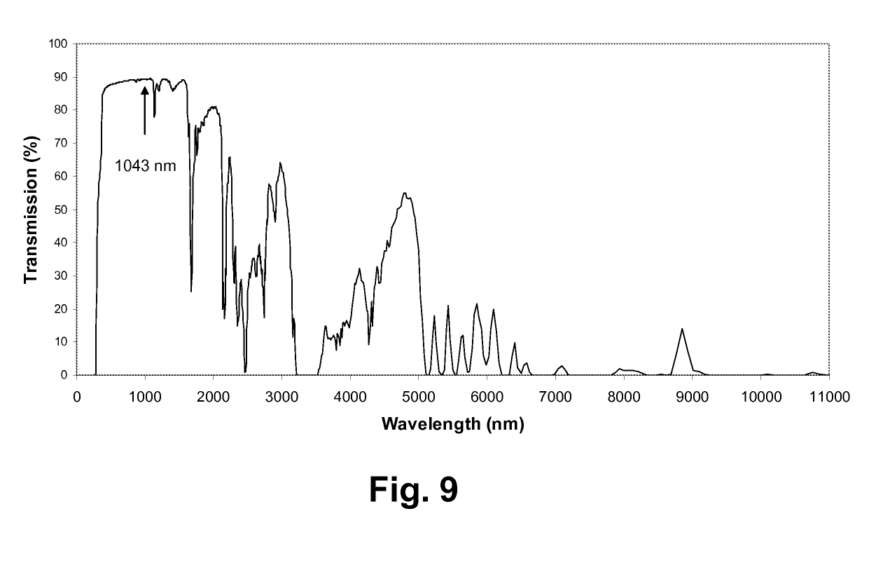

FIG. 9 is a graph showing a transmission spectrum, including some transparency windows, for polystyrene, measured from a 1 mm thick piece of polystyrene (Dow 685D). Transparent window (or transparency window), for the purposes of this disclosure, means the range of wavelengths of light that can pass through the material with a useful transmission. For example, the transparency window may be above approximately 60% transmission, above 70% transmission, above 80% transmission or above approximately 90% transmission. In embodiments, lasers generating beams within this range of wavelengths can be used to mark transparent materials. The measurements were taken from a broad band light source from 2500 nm to 200 nm transmittance using a Perkin-Elmer 950 spectrophotometer, with 60 mm diameter integrating sphere, using the following parameters: spectral bandwidth (PMT): 2.0 nm; PbS Servo, Gain: 5; Signal Average Time: 0.5 sec; Scan Speed: 180 nm/min; Detector Change: 850 nm; Aperture: None. The sample was measured for IR transmittance using a Nicolet Nexs 670 FTIR using the following parameters: Scans: 64; Resolution: 8 cm⁻¹; Iris: 30%; Gain: 1; Aperture: 6 mm×19 mm. As shown in FIG. 9, the transparency window for polystyrene (above approximately 60% transmission) is between about 340 nm and about 2100 nm. The transparency window of polystyrene material (above approximately 85% transmission) is from about 390 nm to about 1610 nm.

In embodiments, the material to be marked may be polystyrene, polycarbonate, polyethylene terephthalic ester, or cyclic olefin copolymers, for example, although any transparent polymeric material may be used. In addition, the material may have layers of material on top of or below the polymer to be marked. This will not affect the marking methods of the present invention, as long as the layers of material above the mark are also transparent to the wavelength of energy being provided by the laser.

In the following, non-limiting examples are presented, which describe various embodiments of the articles and methods discussed above.

### EXAMPLES

### Example 1

### Single Laser Welding

Marks were provided in a polystyrene workpiece using a single pulsed fiber laser, as shown in FIG. 1. While marking polystyrene workpieces are described here, polycarbonate, polyethylene terephthalic ester, polyphenylene oxide, and cyclic olefin copolymer workpieces have also been marked according to embodiments of the present invention, and would be suitable for welding according to embodiments of the present invention.

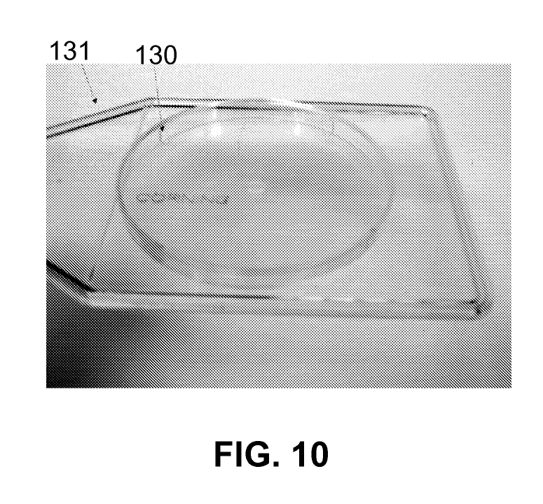

FIG. 10 is a photograph of a polystyrene disc 130 welded to a polystyrene plate 131. The polystyrene (Dow 685D) disc had a diameter of 5.5 cm and a thickness of 1.1 mm. The polystyrene plate was made from the same Dow 685 polystyrene and also had a thickness of 1.1 mm. The plate was held on a three axis translation stage, and the disc was put on top of the plate. To keep close contact between the two parts, a metal weight was put on top of the disc, but was placed outside of the area to be welded. As shown in FIG. 9, the transparency window of the polystyrene (Dow 685D), is from 390 nm to 1610 nm.

The pulsed fiber laser system is described in co-pending U.S. patent application Ser. No. 12/510,360 filed on Jul. 28, 2009 entitled Method for Providing Sub-Surface Marks in Polymeric Materials, having the same inventors as the present invention, and also being subject to assignment to Corning Incorporated.

An Yb-doped pulse fiber laser system was used to provide laser beam 111 (as shown in FIGS. 2-8). The center wavelength of the output pulses was 1043 nm (shown as the arrow in FIG. 9) which was in the transparent window of the polystyrene material. The fiber pulse laser system consisted of four parts: a seed oscillator, a self-similar amplifier, a pulse picker, and a chirped pulse amplifier (CPA). The seed laser was a passively mode-locked Yb-doped fiber laser, which generated 18.8 MHz pulses with a 3 dB spectral bandwidth of 0.5 nm and a pulsewidth of 5.5 ps (full width at half maximum, the same definition are used in all the following text). The self-similar amplifier was a bi-directional pumped fiber amplifier using low Yb-doped optical fiber. This amplifier was used to broaden the spectrum of the input optical pulses through self-similar amplification. In this process, the pulses were linearly chirped. After this amplifier, the pulse spectrum was broadened to about 10 nm. Then the pulses were launched into the pulse picker which was a fiber pigtailed acoustic modulator. Finally, the pulses were amplified by a CPA system which included a fiber pulse stretcher, a two-stage Yb-doped amplifier, and a pulse compressor formed by a pair of Grisms. This fiber pulse laser system could generate optical pulses with various pulsewidths, pulse repetition rates, and energies. The repetition rate of the output pulses could be discretely changed from 73.6 kHz to 18.8 MHz by using the pulse picker. The pulsewidth could be continuously tuned from ˜700 fs to ˜35 ps by tuning the compressor. The energy the output pulses could be tuned up to 20 pJ. The pulse laser beam was focused and scanned underneath the top surface (contact surface with the disc, 130) of the plate (131) by a galvano-scanning system with an 80 mm focal length lens. FIG. 10 shows the photo of the two polystyrene samples which were welded using the pulse fiber laser. The laser beam was focused just under the top surface of the plate (131). The pulsewidth, average power, and repetition rate of the laser pulses were 2.0 ps, 0.3 W and 295 kHz respectively. The beam diameter at the focus was about 20 μm. As shown in FIG. 10, the welding seams were the text “Corning” which was formed by scanning the laser beam. The black color of the Corning text indicates that the polystyrene was carbonized. Four passes of the laser beam were used in the welding. The third and fourth pass shifted 0.1 mm in both x and y axes (z direction is perpendicular to the welding surface) directions. The scan speed of each pass was 1 mm/s. This process was suitable to join (weld) the two pieces at the location of the text.

### Example 2

### Two Laser Welding

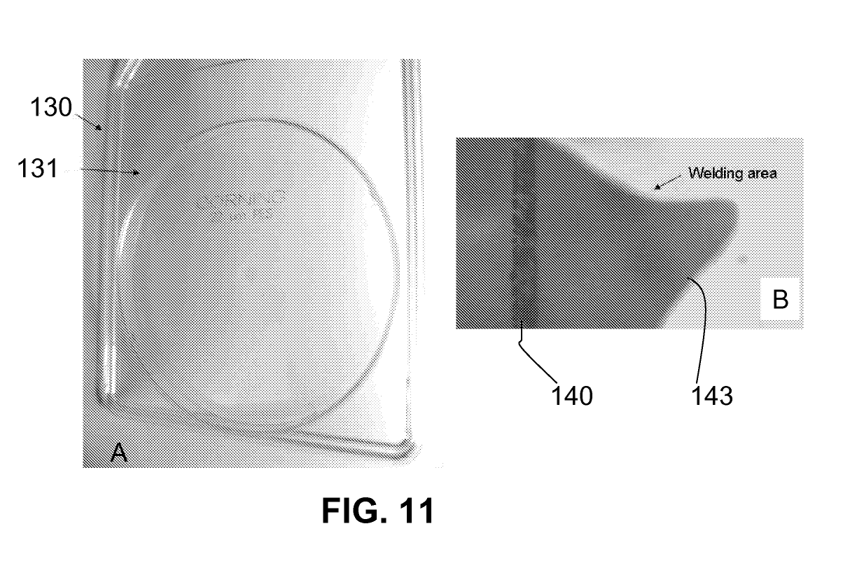

FIGS. 11A and B are photographs of parts (130 and 131) welded together using an embodiment of the two-laser method described in FIGS. 5-8. Again, the samples used in the experiment were one polystyrene disc (130) and one polystyrene plate (131). The pulse laser beam 1 (with wavelength λ₁=1043 nm) was generated by the same pulse fiber laser described in Example 1 above. The second laser beam (with wavelength λ₂=980 nm) was generated by a continuous wave diode laser. First, black text “CORNING” and “0.22 um PES” were marked underneath the top surface of the plate (131) (˜0.2 mm under the top surface) by using the pulse fiber laser with the galvano-scanning system with an 80 mm lens. The fiber laser parameters were the same as that used in the Example 1. Multiple-pass marking method was used in the marking. Each marking consisted of 10 passes of laser beam scan: a slow scan speed (40 mm/s) for the first pass and fast scan (150 mm/s) in following passes (2-10 passes). The beam shifted 0.1 mm in both x and y axes (z direction is perpendicular to the welding surface) directions between two passes. Then, the plate and the disc were clamped together, and the area of the black letters “NI” was irradiated by the collimated output beam of the diode laser. The diameter of the collimated beam was ˜5 mm. The output power of the diode laser was 20.6 W. After about 20 seconds, a solid joint was produced around irradiated letters “NI”.

FIG. 11B shows a photo of the welded parts. FIG. 11B shows an enlarged image of the top part of letter “I” which was taken by a microcope with 5× magnification. The black line is the letter “I” (140) marked by the pulse fiber laser, and dark area around the line (143) is the weld spot.

The invention being thus described, it would be obvious that the same may be varied in many ways by one of ordinary skill in the art having had the benefit of the present disclosure. Such variations are not regarded as a departure from the spirit and scope of the invention, and such modifications as would be obvious to one skilled in the art are intended to be included within the scope of the following claims and their legal equivalents.

1. A method for making welds between transparent polymeric materials comprising:
providing at least two transparent polymeric materials to be welded together, each having a top surface and a bottom surface, wherein the top surface of one polymeric material is adjacent to the bottom surface of another polymeric material and wherein the transparent polymeric materials have transparency windows;
providing an optical system structured and arranged to focus a laser beam at a weld spot on the top surface of one polymeric material or the bottom surface of another polymeric material where the transparent materials are adjacent to each other;
providing at least one pulsed laser which produces a pulsed laser beam at a wavelength within the transparency windows of the at least two polymeric materials;
focusing a pulsed laser beam on the weld spot;
wherein the weld spot turns dark in response to the laser beam focused on the weld spot by the pulsed laser;
focusing a laser beam at or near the dark weld spot; and,
forming a weld zone between the at least two transparent polymeric materials.

2. The method of claim 1 comprising providing additional welds between the at least two transparent polymeric materials by re-focusing the pulsed laser beam to additional weld spots.

3. The method of claim 2 comprising providing at least three transparent polymeric materials.

4. The method of claim 1 comprising providing additional welds between the at least two transparent polymeric materials by re-focusing the pulsed laser beam to additional weld spots at the interfaces provided by at least three layers of transparent polymeric materials.

5. The method of claim 1 wherein the transparent polymeric materials comprise the same transparent polymeric material.

6. The method of claim 1 wherein the transparent polymeric materials comprise different transparent polymeric materials, having overlapping transparent windows.

7. The method of claim 1 wherein the step of focusing a pulsed laser beam on the weld spot is provided by the same pulsed laser as the step of focusing a laser beam at or near the dark weld spot to form a weld zone.

8. The method of claim 1 wherein the step of focusing a pulsed laser beam on the weld spot is provided by a different laser than the step of focusing a laser beam at or near the dark weld spot to form a weld zone.

9. The method of claim 8 wherein the laser used to focus a laser beam at or near the dark weld spot to form a weld zone is a continuous wave laser.

10. The method of claim 1 wherein at least one transparent polymeric material comprises polystyrene, polycarbonate, polyethylene terephthalic ester, poly(phenylene oxide), or blends of any two or more of these polymers.

11. The method of claim 1 wherein both transparent polymeric materials comprise polystyrene, polycarbonate, polyethylene terephthalic ester, poly(phenylene oxide) or a blend of any two or more of these polymers.

12. The method of claim 1 wherein the at least two transparent polymeric materials have the same transparency windows.

13. The method of claim 1 wherein at least one of the pulsed laser comprises a fiber laser.

14. The method of claim 1 wherein at least one pulsed laser comprises an Yb-doped pulse fiber laser.

15. The method of claim 1 wherein at least one pulsed laser provides laser energy at a pulsewidth of less than 1 ns.

16. The method of claim 1 further comprising moving the laser beam in relation to the at least two transparent polymeric materials to be welded together to form a weld zone.

17. The method of claim 1 further comprising moving the at least two transparent polymeric materials to be welded together in relation to the laser beam to form a weld zone.

18. The method of claim 1 wherein at least one pulsed laser provides a laser pulse repetition rate between 50 kHz and 100 MHz, and a laser pulsewidth less than 1 ns.

19. A welded polymeric apparatus made by the method of claim 1.
